(19) United States
(12) Patent Application Publication
(10) Pub. No.: US 2003/0108376 A1
(43) Pub. Date: Jun. 12, 2003

(54) Propel-repel package for deodorant and antiperspirant sticks

(76) Inventor: David R. Hurlburt, West Cornwall, CT (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/011,057

(22) Filed: Dec. 6, 2001

(51) Int. Cl. B43K 23/00; B43K 21/08

(52) U.S. Cl. 401/88; 401/68

(57) ABSTRACT

Propel-repel packaging assemblies suitable for dispensing solid deodorant or antiperspirant product are provided. The assemblies include a tubular top cap having an open bottom and a closed top, a tubular body having a central axis, an inner wall and an outer wall, and a tubular bottom cap including an inner and outer wall. The packaging also includes a tubular product carrier including a cup for receiving the product and a lower portion for engaging the tubular bottom cap such that the assembly is operable to cause the product disposed within the cup to selectively propel or repel by relative rotation of the tubular bottom cap and tubular body. The preferred packaging assemblies contain thread engagement means providing a pitch of about 0.060″ to 0.250″ for propelling and repelling deodorants or antiperspirants at a customary delivery rate, but without the inconvenience of actuators which must translate through the product in order to deliver it.

### FIELD OF THE INVENTION

This invention relates to propel-repel packaging assemblies suitable for dispensing solid deodorant or antiperspirant product, and more particularly to an assembly which is operable to cause the product to disposed within the cup to selectively propel or repel by a relative rotation of a tubular gripping portion and a tubular body.

### BACKGROUND OF THE INVENTION

Standard mechanisms in the packaging industry for propelling or repelling deodorant sticks include assemblies in which a center screw post, disposed through the product itself, is used to propel the product out of the container. The center post is operable by turning a small wheel at the bottom of the package. There are also deodorant sticks which can be propelled manually by pushing a plastic diaphragm supporting the product through a tubular package body.

While these two systems for the delivery of deodorant and antiperspirant sticks are prolific and commercially successful, they are not without their drawbacks. Specifically, the push up type devices propel the product with no desirable way to repel it, short of physically pushing the product back into the package. The center screw post design is more popular, since it allows the product to be repelled. However, many users complain that the product often loosens from the center post screw before the end of its useful life. Additionally, rotating the small wheel at the base of the package can be difficult for individuals with arthritic or impaired finger joints.

There also remains a need in the packaging industry for deodorant and antiperspirant sticks which provide a “silkier” feel for “high end image” products. This is an important quality differentiator in the consumer market, and can lend itself to higher margins for manufacturers.

### SUMMARY OF THE PREFERRED EMBODIMENT

This invention provides propel-repel packaging assemblies suitable for dispensing solid deodorant and antiperspirant, and methods of loading product in such packaging from the bottom or the top. In a first embodiment of this invention, a propel-repel packaging assembly is provided. The assembly includes a tubular top cap having an open bottom and a closed top. It further includes a tubular body having a central axis, an inner wall and an outer wall. This tubular body includes open extremities and a first annular connecting means at its lower end. It further includes an upper portion having engaging means for releasably securing the top cap.

The assembly further includes a tubular bottom cap having an inner and an outer wall, an open upper extremity and an upper portion having a first thread connecting means. The tubular bottom cap further includes an annular tubular gripping portion disposed radially outwardly from said outer wall of the tubular bottom cap and connected thereto by a bridging portion disposed proximate to a lower portion of said tubular bottom cap. The annular tubular gripping portion forms an annular tubular cavity with the outer wall of the tubular bottom cap for receiving the lower portion of the tubular body. The tubular bottom cap further includes a second annular connecting means, located proximate to the annular tubular cavity, to frictionally and swivelly connect with the first annular connecting means of the tubular body. The assembly finally includes a tubular product carrier including an upper portion having a cup for receiving the product and a lower portion having a support cylinder. The cup optionally includes product sealing means for frictionally engaging the inner wall of the tubular body for helping to seal the product during use. The cup also includes optional product retention means for mechanically locking the product within the cup. The tubular product carrier further includes second thread connecting means for engaging the first thread connecting means of the tubular bottom cap. The packaging assembly is operable to cause the product disposed within the cup to selectively propel or repel by a relative rotation of the tubular gripping motion and the tubular body.

The packaging of this embodiment produces a smooth and luxurious propel and repel delivery of deodorant and antiperspirant stick-like products. The preferred packaging assemblies of this invention are easier to operate, provide a smoother delivery of product and are mechanically different in design from prior packaging related to deodorant sticks, lipstick and make-up. Where earlier deodorant sticks have used a bottom wheel or knob that moves the center screw post through the product itself, the preferred embodiment employs a product carrier for locking in the product, sealing it from leakage, and repelling and propelling it within the package. Accordingly, the propelling mechanism of the preferred embodiment is located substantially beneath the product dispensed and not within it, which provides a much smoother and effortless propelling of the product during use.

In further embodiments of this invention, the deodorant and antiperspirant packaging assembly can be open ended and fitted with a bottom seal for bottom filling the product in the form of a paste or solution which hardens to conform with the space in and above the product cup. In further embodiments, the product cup is sealed from below, so that the product can be dispensed within the cup by top filling a deodorant or antiperspirant paste or liquid, which later hardens and mechanically locks into the cup with the assistance of a product retainer, such as an inner ring disposed at an oblique angle to the central access of the package.

### BRIEF DESCRIPTION OF THE DRAWINGS

The accompanying drawings illustrate preferred embodiments of the invention as well as other information pertinent to the disclosure, in which:

FIG. 1: is a side elevational, cross-sectional view of a preferred propel-repel packaging assembly suitable for top filling;

FIG. 2: is a side elevation, cross-sectional view of an alternative propel-repel packaging assembly suitable for bottom filling;

FIG. 3: is a side elevational view of the propel-repel packaging assembly of FIG.

### DETAILED DESCRIPTION OF THE INVENTION

The preferred embodiments of this invention are designed to selectively deliver solid deodorant and antiperspirant products. Although they may be useful toward the delivery of other products, such as make-up and the like, they provide heretofore unrecognized benefits to the deodorant and antiperspirant marketplace.

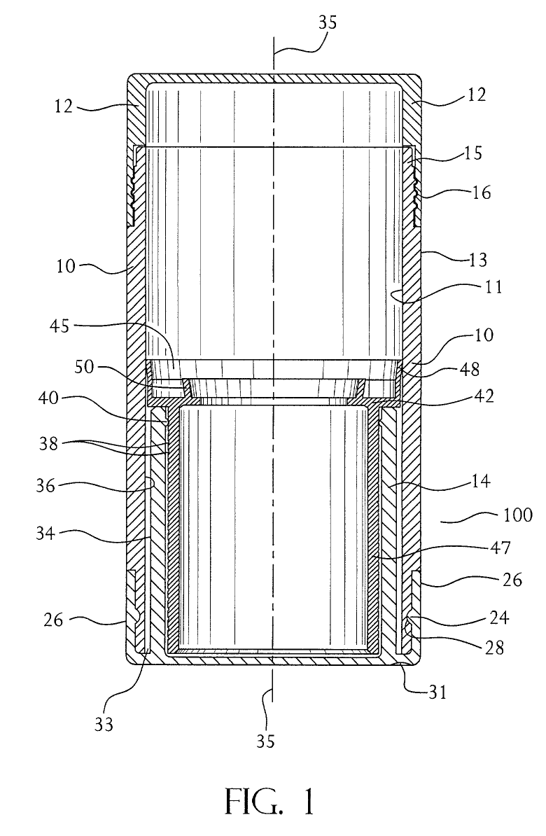

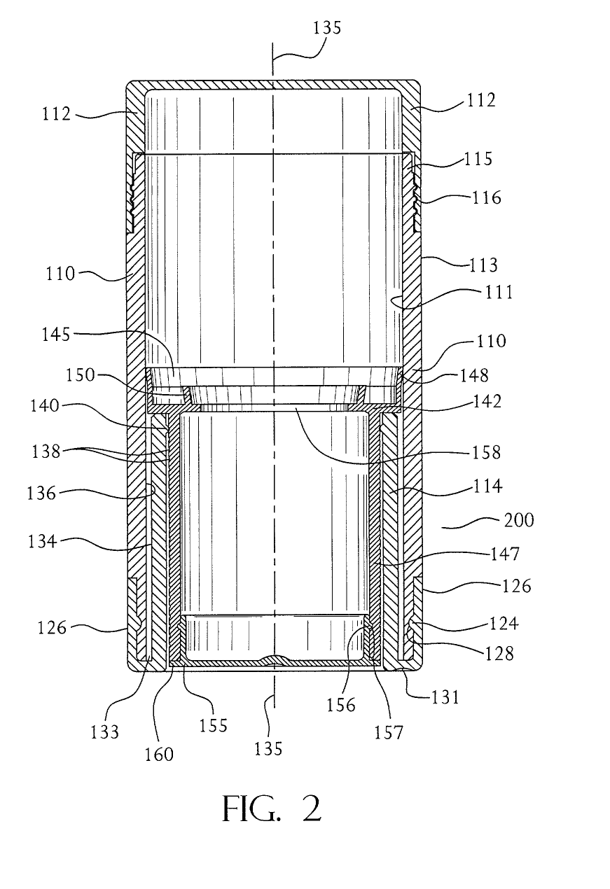

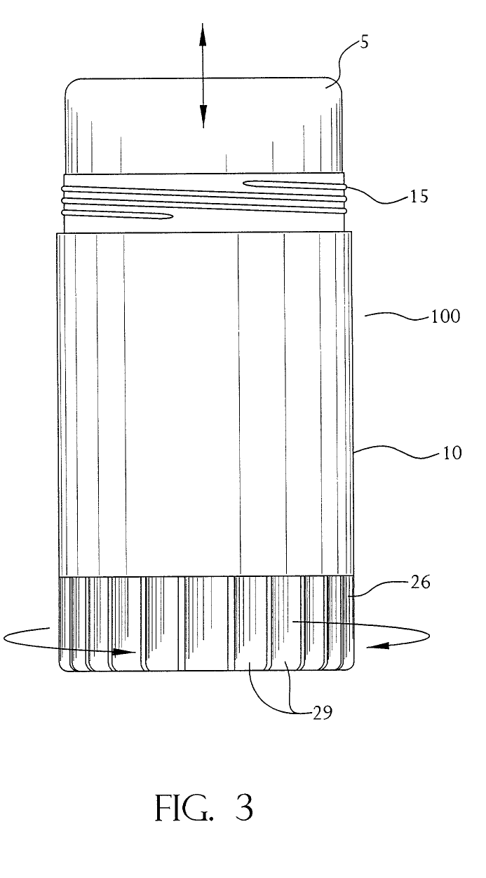

With reference to FIGS. 1-3, there is shown a top fill propel-repel packaging assembly 100 and a bottom fill propel-repel packaging assembly 200. Since these assemblies 100 and 200 are nearly identical, but for a few select features, they will be discussed together.

The preferred assemblies 100 and 200 include tubular bodies 10 and 110, which are desirably molded, such as by injection molding, from inexpensive thermoplastic materials, such as polyethylene, polypropylene, polycarbonate, polyester, acrylic, cellulosics, and nylon. Alternatively, thermosetting polymers could be used, such as phenolics, polyesters, polyurethanes, epoxies, etc. Since the materials suitable for the tubular bodies 10 and 100 are also useful for the other components of the packaging assemblies 100 and 200, this disclosure of preferred alternative resin compositions applies equally to all components described herein.

The tubular bodies 10 and 110 include central axes 35 and 135 disposed through the center of the assemblies 100 and 200, as well as through the deodorant or antiperspirant product 5. Each of the tubular bodies 10 and 110 has an inner wall 11, 111, and an outer wall, 13, 113. Preferably, both extremities of the tubular bodies 10, 110 are open for receiving other components of the packaging assemblies 100 and 200.

The tubular bodies 10 and 110 include a first annular connecting means proximate to their lower portions and engaging means for releasably securing the tubular top caps 12, 112 at the upper portion. In the preferred embodiments of the assemblies 100 and 200, the first annular connecting means are annular recesses 28, 128, which can take on any number of concave shapes, such as semicircular, V-shaped, T-shaped or rectangular, for example. The annular recesses 28, 128 preferably completely circumscribe the lower portion of the tubular bodies 10, 110 to permit a swivel connection with the tubular bottom caps 14, 114. This can be accomplished in various ways, such as, for example, by combining the annular recesses 28, 128 with a mating second annular connecting means, such as annular rings 24, 124 to frictionally and swivelly connect with the first annular connecting means of the tubular bodies 10, 110. Preferably, the first and second annular connecting means are snap fitted together so as to provide resistance to the separation of the tubular bottom caps 14, 114 from the tubular bodies 10, 110.

The tubular bodies 10, 110 also include engaging means, such as threads 15, 115, for reasonably securing the top caps 12, 112. Accordingly, the top caps 12, 112 preferably include engaging means, such as threads 16, 116 for mating with threads 15, 115 of the tubular bodies 10, 110. Alternatively, a snap-fit engaging means or smooth or tapered frictional fit would be sufficient.

The tubular bottom caps 14, 114 also include inner walls 36, 136 and outer walls 34, 134. The upper extremity of the tubular bottom caps 14, 114 preferably includes an opening and a first thread connecting means such as lugs 40, 140. Instead of lugs 40, 140, the first thread connecting means can be represented by a male thread, female thread, or one half of a helical male-female connection. The tubular bottom caps 14, 114 further include annular tubular gripping portions 26, 126, disposed radially outwardly from the outer walls 34, 134 of the tubular bottom caps 14, 114. The gripping portions 26, 126 can include ridges or scallops 29 to aid the user, and are connected to the tubular bottom caps 14, 114 by a bridging portions 31, 131 located proximate to a lower portion of the tubular bottom caps 14, 114. The bridging portions 31, 131 may be a continuous ring connection, or a series of spaced bridging portions located around the circumference of the tubular bottom caps 14, 114. The bridging portions 31, 131 are desirably located near the lower most extremity of the tubular bottom caps 14, 114.

The annular tubular gripping portions 26, 126 form an annular tubular cavity 33, 133 with the outer walls 34, 134 of the tubular bottom caps 14, 114. These tubular cavities can be very thin, about 0.1″ to somewhat thicker, about 0.3″, so long as the material selection of the tubular bodies 10, 110 allows sufficient resiliency during the swivel action of the annular gripping portions 26, 126 about the lower portion of the tubular bodies 10, 110, while leaving sufficient material to make an annular connecting means possible.

The assemblies 100 and 200 further include tubular product carriers 42, 142 which act as elevators to propel and repel the product 5 through the open end of the tubular bodies 10, 110 once the tubular top caps 12, 112 are removed. The tubular product carriers 42, 142 preferably include cups 45, 145 disposed at an upper region, and support cylinders 47, 147, or the like, disposed at a lower region. The product carriers 42, 142 are designed to contain and seal the product during storage and use. The cups 45, 145 can include, for this purpose, a product sealing means for frictionally engaging the inner walls 11, 111 of the tubular bodies 10, 110 to seal the product 5. The product sealing means can include any number of sealing devices, such as a flared exterior wall 48, 148. Alternatively, the product sealing means could include a feathering of the exterior walls 48, 148, which is sized to be equal to or slightly larger than the diameter of the inner walls 11,111, a rubber or synthetic rubber 0-ring disposed in an annular groove in the cups 45, 145, or a sealing lubricant, such as silicone oil disposed on the inner walls 11, 111 of the tubular bodies 10, 110. In a most preferred embodiment, the product sealing means comprises a flared exterior wall 48, 148 which forms the outer ring of the cups 45, 145. The flared exterior wall 48, 148 preferably includes a wall portion that extends at an oblique angle to the central axes 35, 135, and preferably includes a thinner or feathered portion which is biased against the inner wall 11, 111 in frictional sealing contact to substantially prevent the leakage of product 5 from escaping downwardly from the edge of the flared exterior wall 48, 148 during use. If such leakage should occur, it would be contained in the tubular cavities 33, 133 so as to substantially eliminate any fouling of the propel mechanism.

The cups 45, 145 may also include product retention means for mechanically locking the product 5 within the cups 45, 145. In a preferred embodiment, the product retention means is a mechanically locking device that prevents the disengagement of the product 5, such as deodorant or antiperspirant, during propelling, repelling or frictional contact with the body of the user. Such a device can be a thin rib, lug, or inner ring 50, 150, which is situated in a fixed position, such that when the liquid or semi-liquid deodorant or antiperspirant is loaded into the space defined by the tubular bodies 10, 110 and cups 45, 145, and is permitted to solidify, the product retention means substantially prevents an unintended dislodging of the product 5 from the cups 45, 145. In a preferred embodiment, the inner ring 50, 150 is disposed about 0.25-0.5″ from the outer walls 48, 148 of the cups 45, 145 at a preferred oblique angle with respect to the central axes 35, 135. Alternatively, the product retention means could be one or more tabs, prongs or a collar which extends at least partially around the circumference of the inner wall of the cup 45, 145 and extends radially inwardly from said inner wall.

The tubular product carrier 42, 142 of the preferred embodiment also includes a second thread connecting means 38, 138 for engaging with the first thread connecting means, such as lugs 40, 140. In a preferred embodiment, the second thread connecting means is a female thread which acts as a track for the lugs 40, 140 of the first thread connecting means. Alternatively, the second thread connecting means could be a male thread, lug or helical male or female-type connection, so long as it mates with the first thread connecting means so as to propel the tubular product carrier 42, 142 as intended. Although the first and second thread connecting means are disclosed as being on an inside wall of the tubular bottom cap 14, 114 and on an outside wall of the support cylinder 47, 147 of the tubular product carrier 42, 142, this preference is optional, since a tubular bottom cap 14, 114 can be made to be disposed within the support cylinder 47, 147, in which case the first and second thread connecting means could be disposed on an inner wall of the tubular product carrier 42, 142 and an outer wall of the tubular bottom caps 14, 114, respectively.

For bottom filling applications, in which the product is disposed in a liquid or slurry from the bottom of the assembly 200, a bottom seal 155 is used to make a final closure to the lower end of the tubular product carrier 142, such as by closing the opening in the support cylinder 147. The bottom seal 155 preferably is also a tubular member having an open upper extremity and a closed lower extremity. It preferably includes an annular ring 156 for mating with an annular recess 157 on an inner wall of the support cylinder 147. This can also be accomplished, as stated above, by an 0-ring, other snap-fit, plastic weld, or frictional fit connection, for example. The bottom seal 155 also may include a flange 160 providing a stop against unintended further penetration into the support cylinder 147.

The packaging assemblies 100 and 200 are designed for top filling and bottom filling respectively. In the top fill propel-repel packaging assembly 100, the product is disposed into the cup 45 through the opening in the upper portion of the tubular body 10. The product 5 can be liquid, semi-liquid, or solid and melted in place, so that the product is locked into the cup 45 around inner ring 50. Since the cup 45 has a solid bottom, the product is retained in the cavity formed by the cup 45 shape and the inner wall 11 of the tubular body 10. The tubular top cap 12 is then secured over the opening in the tubular body 10.

In the bottom fill propel-repel packaging assembly 200, the cup 145 has an open cup bottom 158. The bottom seal 155 is not initially present, and the packaging assembly 200 is disposed upside down on a conveyor belt, with the tubular top cap 112, or equivalent top seal, in place. Liquid, semi-liquid or solid, which is later moltenized, product 5 is inserted through the tubular opening of the support cylinder 147 and through the open cup bottom 158 so as to fill the space formed by the inner wall 111 of the tubular body 110. The liquid or semi-liquid fill level should be enough to contact the inner ring 150, to form a mechanical lock, following solidification of the product 5. Following solidification, the bottom seal 155 is inserted and the annular ring 156 forms a snap fit within the annular recess 157 to secure the bottom seal 155 into position.

During use, the assemblies 100 and 200 are operable to cause the product 5 disposed within the cups 45 and 145 to selectively propel or repel along the central axes 35 and 135 by a relative rotation of the tubular annular gripping portions 26, 126 and the tubular bodies 10, 110. This causes a translation of the lugs 40, 140 along the female threads 38, 138, which are located on the outer wall of the support cylinders 47 and 147, which, in turn, move the tubular product carriers 42, 142 and cups 45, 145 to cause the product 5 to propel or repel as desired. The first and second thread connecting means should establish a pitch of about 0.06″ to 0.25″ and at least about 0.025″. Desirably, the female threads 38, 138 should be spaced about 4-20 threads per inch to provide a propel-repel action suitable for deodorant or antiperspirant stick delivery.

From the foregoing, it can be realized that this invention provides improved packaging assemblies suitable for dispensing solid deodorant and antiperspirant product. The packaging assemblies of this invention preferably employ thread connecting means and a tubular bottom cap that provides conventional pitch spacing for deodorant and antiperspirant products, but delivers the product in a smoother, less encumbered fashion since the product and the mechanics for propelling and repelling are separated from one another, either partially or nearly completely, by a protective tubular product carrier and product seal along the cup which retain the product. Additional improvements provided by this invention are a product retention means that mechanically locks the product in the tubular product carrier after it is either loaded from the bottom or the top. This invention enables selective top or bottom loading with a relatively small number of components, such as four components for top delivery and only five components for bottom delivery. Although various embodiments have been illustrated, this is for the purpose of describing and not limiting the invention. Various modifications, which will become apparent to one skilled in the art, are within the scope of this invention described in the attached claims.

We claim:

1. A propel-repel packaging assembly suitable for dispensing solid deodorant or antiperspirant product, comprising:
(a) a tubular top cap having an open bottom and a closed top;
(b) a tubular body having a central axis, an inner wall and an outer wall, said tubular body having both extremities open, with a lower portion having a first annular connecting means and an upper portion having engaging means for releasably securing said top cap;
(c) a tubular bottom cap having an inner and outer wall, an open upper extremity and an upper portion having first thread connecting means, an annular tubular gripping portion disposed radially outwardly from said outer wall of said tubular bottom cap and connected thereto by a bridging portion disposed proximate to a lower portion of said tubular bottom cap, said annular tubular gripping portion forming an annular tubular cavity with said outer wall of said tubular bottom cap for receiving the lower portion of said tubular body, said tubular bottom cap having a second annular connecting means proximate to said annular tubular cavity to frictionally and swivelly connect with the first annular connecting means of said tubular body; and
(d) a tubular product carrier including an upper portion having a cup for receiving said product and a lower portion having a support cylinder; said cup comprising a product sealing means for frictionally engaging the inner wall of said tubular body for helping to seal said product during use, said cup also including product retention means for mechanically locking said product within said cup, said tubular product carrier further comprising second thread connecting means for engaging said first thread connecting means of the tubular bottom cap; and
(e) said assembly being operable to cause said product disposed within said cup to selectively propel or repel by a relative rotation of said tubular gripping portion and said tubular body.

2. The assembly of claim 1 wherein said cup has an open cup bottom for bottom filling product into said assembly.

3. The assembly of claim 1 wherein said first thread connecting means of said tubular bottom cap comprises a pair of spaced apart lugs and said second thread connecting means of said tubular product carrier comprises a series of threads.

4. The assembly of claim 1 wherein said product retention means comprises an extended plastic member integrally fabricated with said tubular product carrier and extending from an inner wall of said cup at an angle which is not parallel to said central axis of said tubular body.

5. The assembly of claim 1 wherein said product retention means comprises an annular ring portion which extends up from a bottom of said cup at an angle which is oblique to the central axis of the tubular body.

6. The assembly of claim 5 wherein said annual ring is substantially concentric with an outer wall of said cup.

7. The assembly of claim 1 wherein said product's sealing means comprises a portion of the exterior wall of said cup.

8. A propel-repel packaging assembly suitable for dispensing solid deodorant and antiperspirant product, comprising:
(a) a tubular top cap having an open bottom and a closed top;
(b) a tubular body having a central axis, an inner wall and an outer wall, said tubular body having both extremities open, with a lower portion having a first annular connecting means and an upper portion having engaging means for releasably securing said top cap;
(c) a tubular bottom cap having an inner wall and an outer wall, an open upper extremity and an upper portion having first thread engaging means, an annular tubular gripping portion disposed radially outwardly from said outer wall of said tubular bottom cap and connected thereto by a bridging portion disposed proximate to a lower portion of said tubular bottom cap, said annular tubular gripping portion forming an annular tubular cavity with said outer wall of said tubular bottom cap for receiving the lower portion of said tubular body, said tubular bottom cap having a second annular connecting means proximate to said annular tubular cavity to frictionally and swivelly connect with said first annular connecting means of said tubular body;
(d) a tubular product carrier including an upper portion having a cup for receiving said product and a lower portion having a support cylinder; said cup comprising an outer wall which presses against the inner wall of said tubular body to substantially seal in said product during use; said cup also including product retention means comprising at least one inner ring disposed on a bottom of said cup and extending at an angle which is oblique to the central axis of said tubular body, said product retention means adapted for mechanically locking said product within said cap, said tubular product carrier further comprising a second thread engaging means having a pitch of about 0.060″ to 0.25″ for engaging with the first thread engaging means of the tubular bottom cap; and
(e) said assembly being operable to cause said product disposed within said cup to selectively propel and repel by a relative rotation of said tubular gripping portion and said tubular body.

9. The assembly of claim 8 wherein said outer wall of said cup comprises a flared edge portion.

10. The assembly of claim 8 wherein said tubular product carrier and said tubular bottom cap each comprise an open lower extremity for bottom filling a product into said assembly.

11. The assembly of claim 10 comprising a bottom seal disposed to snap fit within the open lower extremity of said tubular product carrier.

12. The assembly of claim 11 wherein said bottom seal is carried by said tubular product carrier during the propelling and repelling of said assembly.

13. The assembly of claim 8 wherein said assembly comprises no more than four molded plastic parts.

14. The assembly of claim 11 wherein said assembly comprises no more than five molded plastic parts.

15. A propel-repel packaging assembly containing a solid deodorant or antiperspirant product, comprising:
(a) a tubular top cap having an open bottom and a closed top;
(b) a tubular body having a central axis, an inner wall and an outer wall, said tubular body having both extremities open, with a lower portion having a first annular connecting means and an upper portion having engaging means for releasably securing said top cap;
(c) a tubular bottom cap having an inner and an outer wall and first thread connecting means, an annular tubular gripping portion disposed radially outwardly from said outer wall of said tubular bottom cap and connected thereto by a bridging portion disposed proximate to a lower portion of said tubular bottom cap, said annular tubular gripping portion forming an annular tubular cavity with said outer wall of said tubular bottom cap for receiving the lower portion of said tubular body, said tubular bottom cap having a second annular connecting means proximate to said annular tubular cavity to frictionally and swivelly connect with said first annular connecting means of said tubular body;
(d) a tubular product carrier including an upper portion having a cup for receiving said product; said cup comprising an extended portion which is not parallel with the cental axis of the tubular body; said extended portion positioned for mechanically locking said product within said cup, said tubular product carrier further comprising second thread connecting means for engaging with the first thread connecting means of the tubular bottom cap; and
(e) said assembly being operable to cause said product disposed within said cup to selectively propel or repel by a relative rotation of said tubular gripping portion and said tubular body.

16. The assembly of claim 15 where in said tubular product carrier further comprises product sealing means for frictionally engaging the inner wall of said tubular body for helping to seal said product during use.

17. The assembly of claim 16 wherein said product sealing means comprises a portion of an exterior wall of said cup.

18. The assembly of claim 15 wherein said second thread connecting means disposed on said tubular product carrier comprises threads having a pitch of about 0.060″ to about 0.250″ and a thread spacing of about 4-20 threads per inch.

19. The assembly of claim 15 wherein said tubular bottom cap and said tubular product carrier each comprise open lower extremities for bottom filling of said product.

20. A propel-repel packaging assembly containing a solid deodorant or antiperspirant product, comprising:
(a) a tubular top cap having an open bottom and a closed top;
(b) a tubular body having a central axis, an inner wall and an outer wall, said tubular body having both extremities open, with the lower portion having an annular recess disposed on said outer wall and an upper portion having engaging means for securing the tubular top cap;
(c) a tubular bottom cap having an inner and outer wall, an open upper extremity and an upper portion having the first thread connecting means, and an annular tubular gripping portion disposed radially outwardly from said outer wall of said tubular bottom cap and connected thereto by a bridging portion disposed proximate to a lower portion of said tubular bottom cap, said annular tubular gripping portion forming an annular tubular cavity with said outer wall of said bottom cap for receiving the lower portion of the tubular body, said tubular bottom cap having an annular ring located proximate to said annular tubular cavity for frictionally and swivelly connecting with the annular recess of said tubular body; and
(d) a tubular product carrier including an upper portion having a tubular cup for receiving said product and a lower portion having a support cylinder; said tubular cup comprising an outer wall and an inner ring which extends up from a bottom portion of said tubular cup, said outer wall and said inner ring having portions which are not parallel with the central axis of said tubular body, said tubular product carrier further comprising second thread connecting means disposed on said support cylinder for engaging with the first thread connecting means on the bottom cap, such that the assembly is operable to cause said product disposed within said tubular cup to selectively propel or repel by relative rotation of said tubular gripping portion and said tubular body.
